(19) United States
(12) Patent Application Publication
(10) Pub. No.: US 2025/0131341 A1
(43) Pub. Date: Apr. 24, 2025

(54) RESHARING OF OWNED ASSET RESERVATIONS

(71) Applicant: Lisa Seacat DeLuca, Bozeman, MT (US)

(72) Inventor: Lisa Seacat DeLuca, Bozeman, MT (US)

(21) Appl. No.: 18/491,490

(22) Filed: Oct. 20, 2023

(51) Int. Cl. G06Q 10/02; G06Q 30/0208; G06Q 30/0645

(52) U.S. Cl. CPC G06Q 10/02; G06Q 30/0208; G06Q 30/0645

(57) ABSTRACT

A resharing of a reservation of a owned asset is disclosed. A second user can reserve the owned asset of a first user. The second user can then list the reservation. A third user may then book the listed reservation. The system may transfer the reservation from the second user to the third user for the owned asset of the first user. Upon the booking of the third user of the reservation, the third user may be granted access to the owned asset of the first user for the reservation period. The system may request a review from the third user to review the asset owned by the first user and the first user to review the third user after the reservation ends. Furthermore, the first and second user may be compensated based on a price difference. Furthermore, the resharing of the reservation may be reshared with additional users.

### TECHNICAL FIELD

The present invention relates to the field of secondary reservations and, more particularly, to the resharing of a first reservation of a first owned asset of a first user by a second user such that the second user and the first user are compensated based on a third user booking the reservation.

### BACKGROUND

### Discussion of the Related Art

Reservations are agreements in which at least one user is granted access to an asset owned by an asset owner for a reservation period. The asset may be a digital asset or a physical asset. Oftentimes there are service providers that offer a marketplace for advertising assets and viewing availability for possible reservations to be booked by a reservation user. For example, with vacation rental services, a homeowner may offer part or all of their homes for rent. Popular vacation rental services include, but are not limited to, Airbnb Inc., HomeAway, VRBO, 9flats.com Pte Ltd., Booking Holdings Inc., Expedia Group Inc., Hotelplan Holding AG, MakeMyTrip Pvt. Ltd., NOVASOL AS, Oravel Stays Pvt. Ltd., TripAdvisor Inc. and Wyndham Destinations Inc. . . . Most reservation service providers offer a web based tool or mobile application which allows reservation users to book or reserve an asset through the service. The service may show details about the owner of the asset being reserved, details about the asset such as the city, state, size, description, amenities, access information, and pricing details. Once the reservation is booked, the reservation user may receive information about how to access the asset during the reservation period on or before the reservation start time. The service providers typically handle payouts and may take a service fee from either the asset owner or the reservation user, or both. After the reservation period is completed, the reservation user as well as the asset owner may be prompted to write a review.

Reservation users choose to use reservation services for a number of reasons. Many reservation users might not own a similar asset or the asset is not available in a specific location or date. Oftentimes the reservation user may need to cancel or modify the reservation for a number of reasons. Sometimes the asset owner sets cancellation and modification policies and other times those rules are set by the service provider and enforced by the service provider. Insurance and trust are other reasons reservation users choose to use a reservation service.

### BRIEF SUMMARY

One aspect of the present invention can include a resharing of an owned asset of a first user based on a reservation. The reservation may be associated with a second user requiring the owned asset. The second user can list the owned asset of the first user. For example, the first user may have a change in plans and needs to cancel or modify the reservation and may prefer to list the reservation for resharing. Additionally, the first user and the second user may have preferences for the listing of the reservation such as the minimum or maximum duration for booking the reservation. Furthermore, the second user may set a price for the listing of the reservation. For example, the second user may set a nightly price more than, less than, or equal to their reservation for the owned asset of the first user. The listing may be booked by a third user. The booking may be for the same reservation period, a shorter reservation period, or a longer reservation period than the reservation period of the second user. Additionally, the reservation of the owned asset of the first user may be transferred from the second user to the third user upon booking. For example, the details about the first user and owned asset such as their identifying information, contact information, user verification, asset information, and payout information, as well as access information may be shared with the third user upon booking the listed reservation from the second user. Furthermore, any details about the second user would therefore be modified to reflect the details about the third user for the benefit of the first user. For example, an asset owner may need to know who has reserved their asset and the reservation user may need to know how to contact the owner.

Another aspect of the present invention can authorize access to the owned asset of the first user based on the reservation period. The reservation period may have a start date, an end date, a start time, and an end time. For example, the reservation period might authorize access to the reservation user for an entire calendar day, week, month, year, or for a portion of the day such as after 3 pm but ends at 11 am on a reservation end date. In yet another example, the reservation period may be for a set number of minutes, hours, or days. The reservation user may wish to start their reservation later or end earlier than the reservation period, however, the authorization period may allow access for the entire reservation period. In yet another aspect of the present invention, the authorization is revoked from the second user upon booking of the reservation period by the third user. For example, if the second user lists their reservation and a third user books the reservation, the second user may no longer have access to the owned asset of the first user. In yet another aspect of the present invention, the authorization is granted to the third user upon booking the reservation of the second user. For example, the third user may receive an access code if the asset is locked.

Yet another aspect of the present invention can include the compensation based on the difference in the first price associated with the owned asset of the first user for the reservation of the second user and the second price associated with the owned asset of the first user for the reservation of the third user. The first user and second user may be compensated in the form of monetary compensation or reward compensation. The difference between the first price and second price may be a higher price, a lower price, or a equal price. For example, a second user may lose 100% of the money spent on a reservation due to a cancellation policy so they may wish to try to recoup anything and therefore may list the reservation for less than the first price they spent on the reservation. For example, the second user may have spent $100 a night for a reservation and was willing to take a loss and list at $50 a night. In yet another example, the second user may try to make a profit on the listing of their reservation. For example, the second user may have paid a first price of $100 a night for a reservation but may think it is worth $200 a night. The third user may agree to pay $200 a night and therefore the difference in price between the first price of $100 and the second price of $200 is $100. In yet another aspect of the invention the first user is compensated. For example, the owner of the asset may receive $140 when an asset that was previously booked for a first price of $100 a night was booked for $200 a night.

Another aspect of the present invention can include a review by the third user of the owned asset of the first user and a review of the first user of the third user based on the reservation. For example, when the reservation user is transferred between the third user and the second user, the second user no longer has access to the asset and therefore should no longer be asked to review the asset. Similarly, the owner of the asset may review the third user as the third user was the user who had access to the owned asset for the reservation period. The first user may not review the second user as the second user transferred their reservation to the third user.

Another aspect of the present invention can include the transfer of contact information when the reservation user is transferred between the third user and the second user, the second user no longer has access to the asset and therefore may no longer have contact information for the first user. Similarly, the owner of the asset may need to contact the third user as the third user is the user who may access the owned asset for the reservation period. The first user may no longer need to contact the second user as the second user transferred their reservation to the third user. For example, the asset owner may need to contact a guest staying in their vacation rental and may use a messaging service for the reservation service. In yet another example, the conversation within the messaging service may be transferred between the asset owner and the second user when the reservation is transferred to the third user.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

FIG. 1A and FIG. 1B are schematic illustrations of a reservation system (100) (150) showing a calendar of booked reservations for the owned asset of the first user in accordance with one embodiment.

FIG. 2 is a flowchart (200) of a process that may be taken for a resharing of an owned asset of a first user based on a reservation in accordance with one embodiment.

FIG. 3 is a schematic illustration of a reservation system (300) in which the system associated with the reservation of the owned asset of a first user provides a prompt to the second user to list the reservation for resharing in accordance with one embodiment.

FIG. 4A and FIG. 4B and FIG. 4C are schematic illustrations of a reservation review system (400) (401) (402) showing a request for review from the first user of the owned asset for the reservation associated with the second user (410) and the reservation associated with the third user (430) as well as a request for review from the second user (401) and the third user (402) of the owned asset of the first user for the reservation upon the reservation period ending (421) (422) in accordance with one embodiment.

FIG. 5 is a schematic illustration of a reservation system (500) in which the booking of the reservation of the second user (510) by the third user (530) is a shorter reservation period than the original reservation of the second user of the owned asset of the first user in accordance with one embodiment.

FIG. 6 is a schematic illustration of a reservation system (600) in which the booking of the reservation of the second user (610) by the third user (630) is a longer reservation period than the original reservation of the second user of the owned asset of the first user in accordance with one embodiment.

FIG. 7 is a schematic illustration of a reservation system (700) in which the first user (720) and the second user (730) are compensated based on a difference in the first price associated with the owned asset of the first user for the reservation of the second user and the second price associated with the owned asset of the first user for the reservation of the third user in accordance with one embodiment.

FIG. 8A and FIG. 8B and FIG. 8C are schematic illustrations of a reservation messaging system (800) (801) (802) showing the transferring of the reservation of the owned asset of the first user for the reservation of the second user from the second user to the third user within the messaging system for the reservation of the owned asset in accordance with one embodiment.

### DETAILED DESCRIPTION

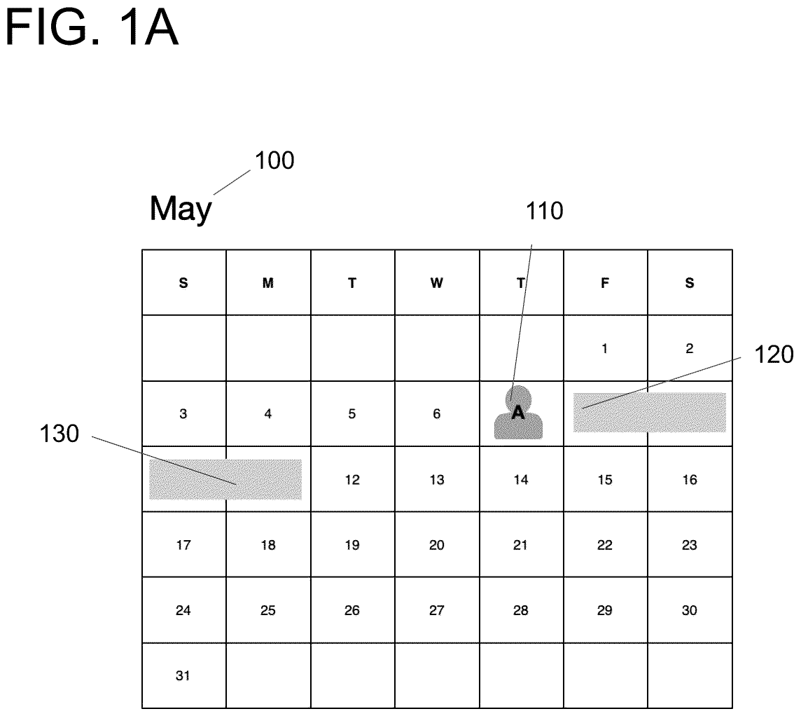

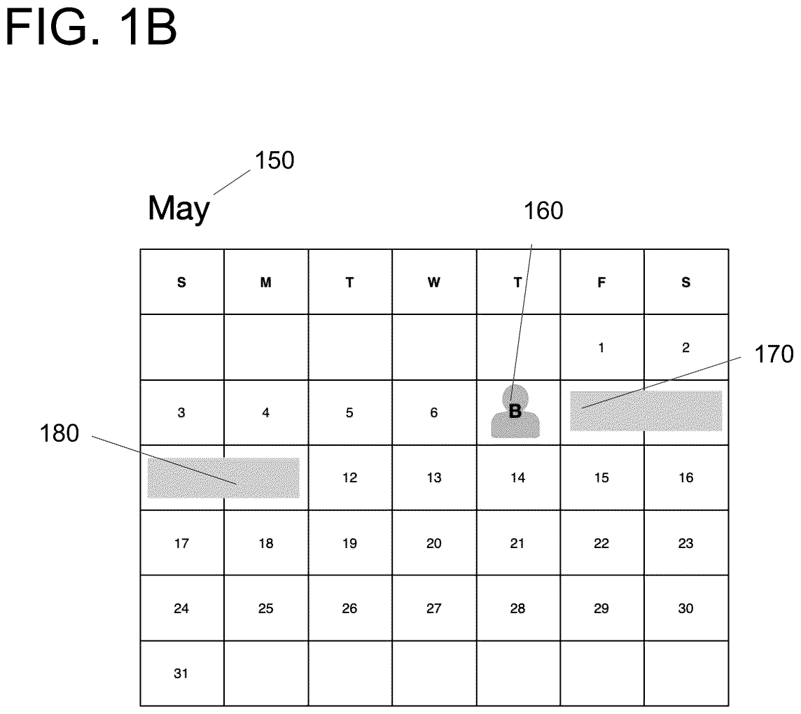

FIG. 1A and FIG. 1B are schematic illustrations of a reservation system (100) (150) showing a calendar of booked reservations for the owned asset of the first user in accordance with one embodiment. The reservation may be associated with a second user (110) and can include identifying information about the second user such as the second user's photo, name, overall rating, email address, phone number, address, city, state, zip code, country, and verification details such as a driver's license, passport, or Know Your Customer “KYC” verifier. Additionally, the reservation information can include a price paid for the reservation, a payout to the owner of the asset, a number of guests, the reservation start which may include a date (120) and time and a reservation end which may include a date (130) and time. For example, the reservation may begin on May 7th at 3 pm MST and end on May 11th at 10 am MST. The second user may list their reservation, and a third user may book the reservation (160) for a start date (170) and end date (180). The calendar of booked reservations for the owned asset of the first user would then be modified to reflect the transferring of the reservation from the second user to the third user (160). For example, Anna may have booked a vacation rental at Henry's home in California from May 7th-May 11th. In the example, Anna lists the reservation dates, May 7th-May 11th as available for reshare. In the example, Bob (160) later books Anna's reservation from May 7th-May 11th and the reservation is transferred for Henry's home in California from Anna to Bob. In the example, Bob's identifying information is reflected in the reservation system for Henry (160). Furthermore, Bob may be authorized to access Henry's home in California for the reservation period between May 7th-May 11th and Anna would not be authorized to access Henry's home for the reservation period between May 7th-May 11th.

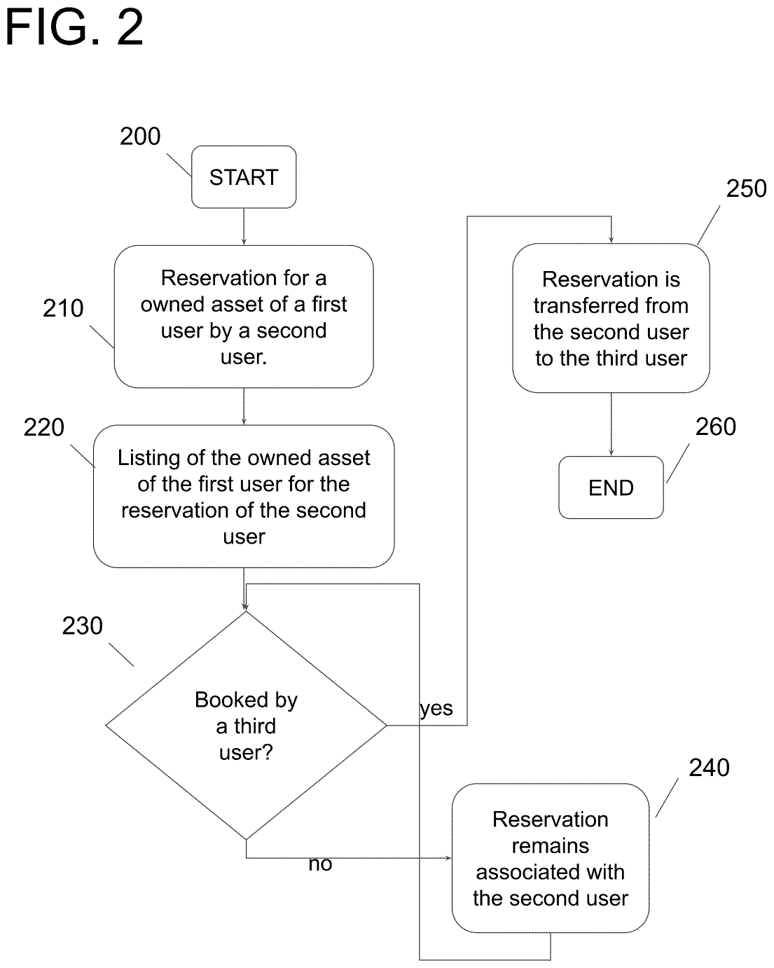

FIG. 2 is a flowchart (200) of a process that may be taken for a resharing of an owned asset of a first user based on a reservation in accordance with one embodiment. A reservation for a owned asset of a first user may be made by a second user (210). The reservation by the second user may then be listed for the owned asset of the first user by the second user (220). The flow may continue by determining whether the reservation for the second user has been booked by a third user (230) based on the owned asset of the first user. If the reservation has not been booked, continue to associate the reservation with the second user (240) and continue to monitor for booking changes (230). If a third user books the reservation, transfer the reservation from the second user to the third user (250). Upon determining the reservation has been transferred from the second user to the third user, the flow ends (260). The step of determining the reservation has been transferred from the second user to the third user may be done by comparing the identifying information of the reservation user. For example, if Anna made a reservation for Henry's vacation rental home and later listed it as available, Bob may book the vacation rental home. Furthermore, if Henry wanted to know who was staying in his space during the reservation period he would see the identifying information for Bob, not Anna once the transfer was complete.

As used herein, the requesting of the resharing of an owned asset of a first user based on a reservation can be implemented within any type of hardware including, but not limited to, a magnetic disk, an optical disk, a semiconductor memory, a digitally encoded plastic memory, a holographic memory, or any other recording medium. Further, the transferring the reservation of the owned asset of the first user for the reservation of the second user from the second user to the third user can use one or more encryption mechanisms to protect stored information from unauthorized access.

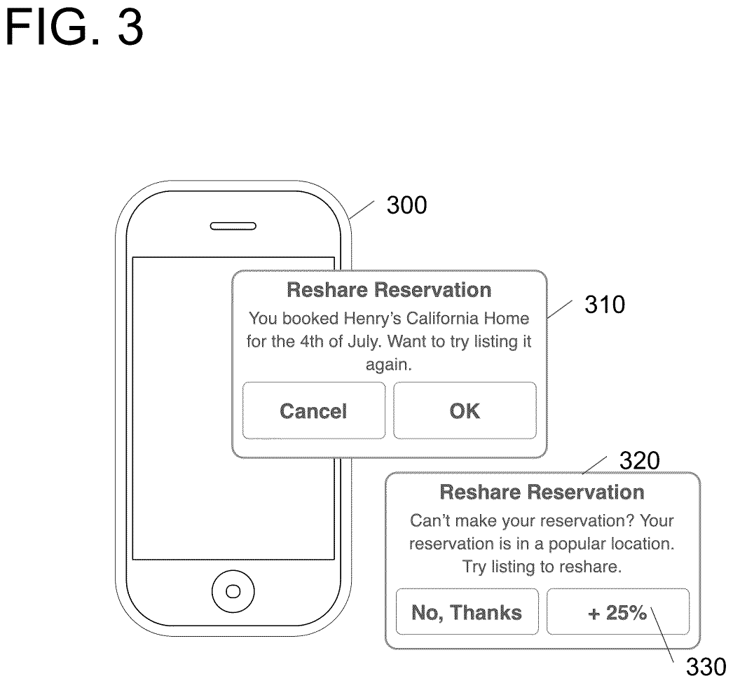

FIG. 3 is a schematic illustration of a reservation system (300) in which the system associated with the reservation of the owned asset of a first user provides a prompt to the second user to list the reservation for resharing in accordance with one embodiment. The prompt may be in the form of a notification (310) within a reservation computer application, a mobile application, a phone call, or a notification through SMS messaging, to name a few. For example, the notification may include a message (310) prompting the second user of the ability to relist their reservation. In the example shown in FIG. 3, the prompt may include information about the reservation period and the owned asset for the first user for the upcoming reservation. For example, if Anna booked Henry's California home, the notification may remind Anna that the home is located in California and her reservation is over the July 4th holiday (310). Furthermore, the system may use trending information to share data about the reservation period (320) and recommend a list price (330). For example, if Henry's California home is located in a popular area, the system may suggest that Anna list for a 25% increase over what she paid for the reservation (330). Furthermore, the price recommendation may be influenced by machine learning and artificial intelligence algorithms. By clicking the button, the reservation may be listed. For example, if Anna paid $100 for her reservation and clicks the button to list, the system may list her reservation as available for $125.

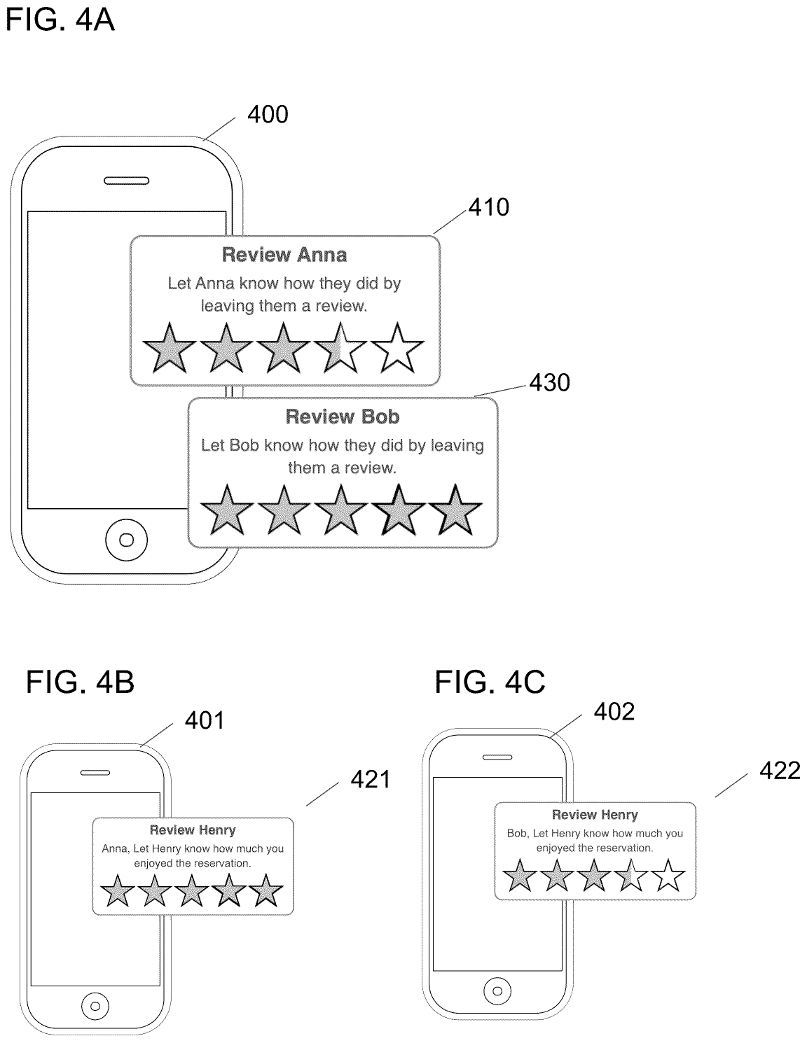

FIG. 4A and FIG. 4B and FIG. 4C are schematic illustrations of a reservation review system (400) (401) (402) showing a request for review from the first user of the owned asset for the reservation associated with the second user (410) and the reservation associated with the third user (430) as well as a request for review from the second user (401) and the third user (402) of the owned asset of the first user for the reservation upon the reservation period ending (421) (422) in accordance with one embodiment. For example, if Anna reserves Henry's vacation rental, lists her reservation for resharing, but a third user never books her reservation and she never cancels, then the system may send a request for review from Henry to review Anna (410) as a guest in his vacation rental (400). Similarly, in the example, the system may send a request for review from Anna (401) to review Henry (421). However, in yet another example, if Bob were to book Anna's listed reservation, then upon the reservation period ending and the transfer of the reservation from Anna to Bob, a request for review may be sent for Bob (402) to review Henry (422), not Anna. Furthermore, Henry would be notified to review Bob (430), not Anna.

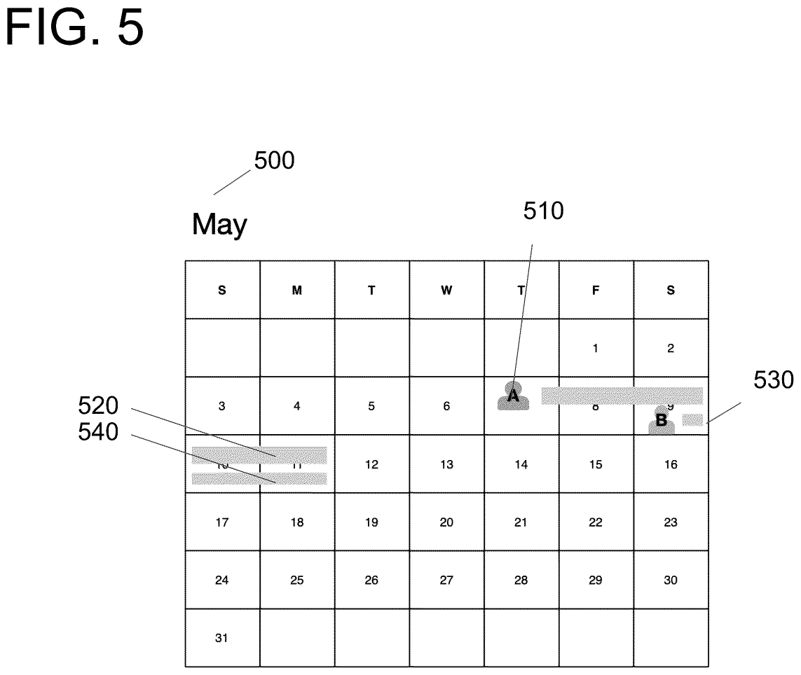

FIG. 5 is a schematic illustration of a reservation system (500) in which the booking of the reservation of the second user (510) by the third user (530) is a shorter reservation period than the original reservation of the second user of the owned asset of the first user in accordance with one embodiment. For example, Anna may have reserved Henry's vacation rental home for the dates of May 7th through May 11th (510). Anna may have listed her reservation within the reservation system for reshare. Depending on the minimum reservation period requirements set by Henry and preferences set by Anna, Bob may have booked a shorter reservation period of the reservation period (530), from May 9th through May 11th. For example, Henry may require that the reservation period be a minimum for 2 nights. Furthermore, Anna may allow or deny partial reservations for the reservation period listed. In the example, if Anna originally paid $100 a night, since she is only staying for two nights, she will pay Henry $200 when her reservation period ends on May 9th. Furthermore, Bob may have booked Anna's reservation for $125 a night, so he may pay $375 for the three nights he will stay at Henry's vacation rental. Furthermore, the asset owner may set a preference to review the third reservation owner before the transfer of the reservation is done between the second and third reservation users. For example, Henry may approve or reject Bob.

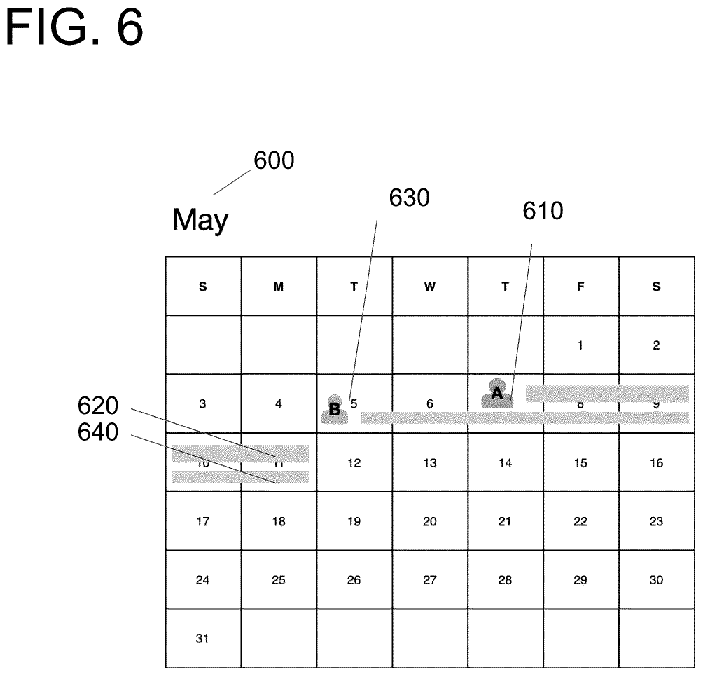

FIG. 6 is a schematic illustration of a reservation system (600) in which the booking of the reservation of the second user (610) by the third user (630) is a longer reservation period than the original reservation of the second user of the owned asset of the first user in accordance with one embodiment. For example, Anna may have reserved Henry's vacation rental home for the dates of May 7th (610) through May 11th (620). Anna may have listed her reservation within the reservation system for reshare. Depending on the maximum reservation period requirements set by Henry and the owned asset availability, Bob may have booked a longer reservation period, from May 5th (630) through May 11th (640). For example, Henry may require that the reservation period be a maximum of 1 month. Furthermore, Henry's vacation rental may already be reserved by a fourth guest either before or after the listed reservation. In the example, neither reservation period preference or availability constraints is a concern. In the example, if Anna originally paid $100 a night, since she is no longer staying any nights, she will pay $0. Furthermore, Bob may have booked Anna's reservation for $125 a night, so he may pay $625 for the five nights he will stay at Henry's vacation rental based on Anna's reservation plus the nightly rate that Henry has set for May 5th and 6th which were not part of Anna's reservation of Henry's vacation rental. In addition, Bob may have a single reservation with Henry for the total duration and may have a single set of fees such as a cleaning fee, taxes, and other service fees. Any compensation to Anna for Bob's booking may be for the original five nights from her reservation. In yet another example, the system may reward Anna for the longer reservation period of Bob's reservation providing compensation for the two additional nights Bob booked as an extended reservation.

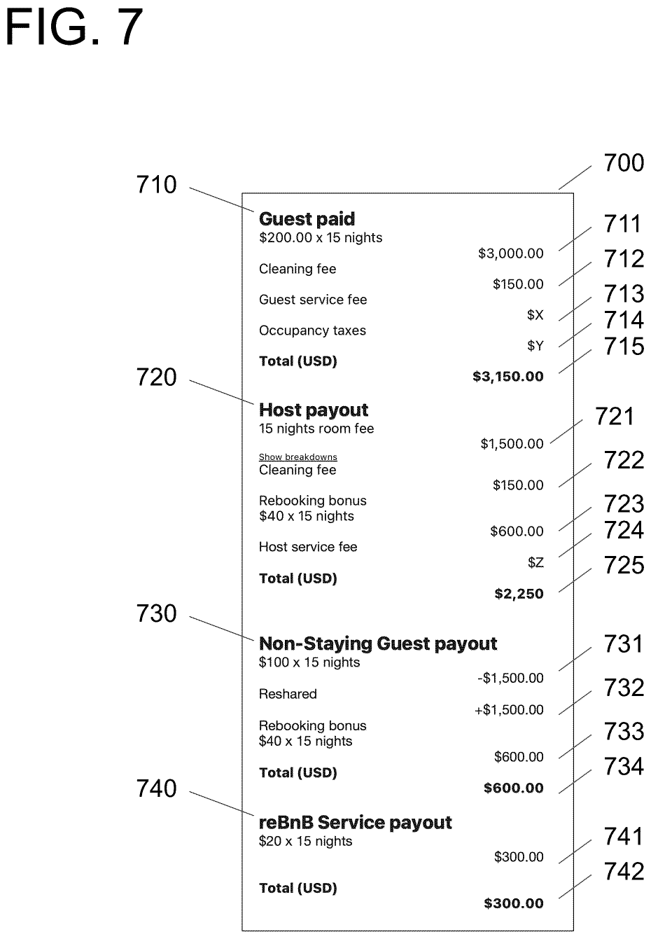

FIG. 7 is a schematic illustration of a reservation system (700) in which the first user (720) and the second user (730) are compensated based on a difference in the first price associated with the owned asset of the first user for the reservation of the second user and the second price associated with the owned asset of the first user for the reservation of the third user in accordance with one embodiment. For example, the second user may set a second price for the listing of the reservation more than, less than, or equal to the first price associated with the owned asset of the first user for the reservation of the second user. For example, Anna books Henry's vacation rental space for $100 a night for 15 nights (731). Anna may list her reservation with the reservation system for reshare for $200 a night. Bob then books Anna's listing (710) for $200 a night for the full 15 nights (711). Therefore, in this example, Anna no longer has to pay the $100 a night for 15 nights (732). Bob may pay any additional fees such as a $150 cleaning fee (712), service fees (713), and occupancy taxes (714) for a total of $3,150 (715) in this example. Henry may receive the original payout of $100 a night for 15 nights from Anna (721), any cleaning fees $150 (722), and he would be compensated based on the difference of the price with Bob's booking (723), which in this example may be $40 a night for 15 nights (723), minus any service fees (724), for a total payout of $2.250 (725), in this example. In this example, Anna would no longer need to pay the $100 nightly rate for 15 nights (732), but may be compensated based on the difference of the price of the new nightly rate difference with Bob's booking (733), which in this example may be $40 a night for 15 nights or $600 (733), for a total compensation of $600 (734). Furthermore, a service fee for the reservation service resharing may be applied (740) based on the price difference (741) with Bob's booking (710) and Anna's original reservation price (730) for a total resharing service fee of $20 a night for 15 nights or $300 (742), in this example. In yet another example, the compensation may be in the form of a reward such as promotional credits, points, future discounts, or free benefits in addition to or instead of monetary compensation. In yet another example, the monetary compensation may be in the form of a blockchain payment such as a cryptocurrency token. In yet another example, the second price may be less than the first price and therefore the second user may lose money on the reservation and may result in a loss of funds. For example, Anna may have originally paid $100 for each night of the reservation but the cancellation policy is strict and the would be losing $100 a night, so she instead lists for $75 a night to recoup some of her original payment. If the listed reservation were booked by Bob at $75 a night, then Anna would be responsible for paying the difference of $25 a night to Henry along with any additional service fees.

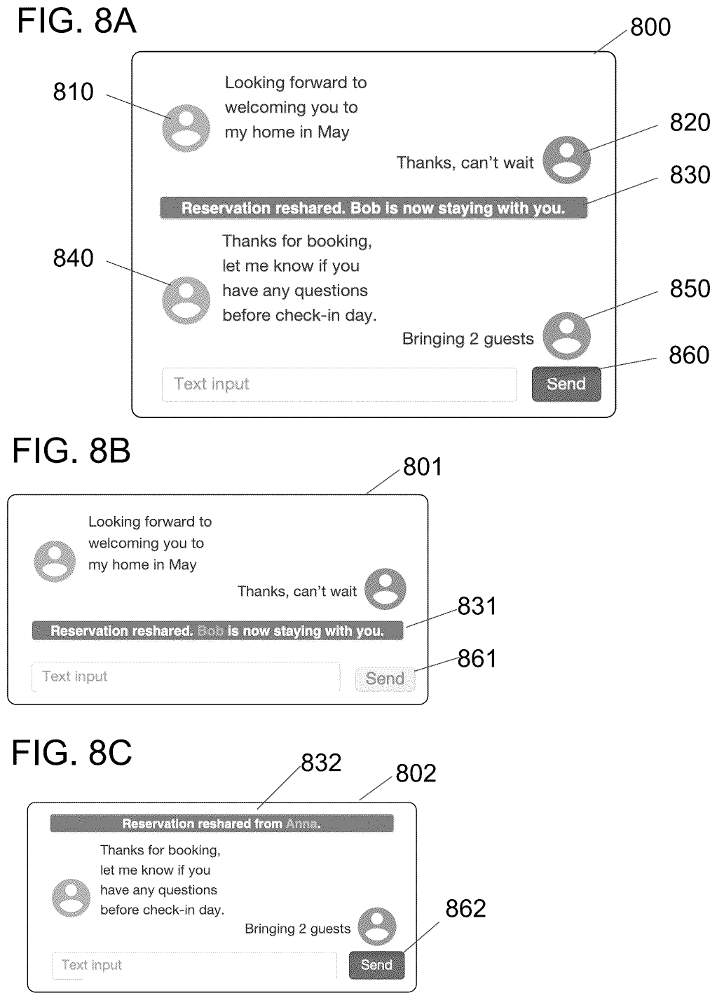

FIG. 8A and FIG. 8B and FIG. 8C are schematic illustrations of a reservation messaging system (800) (801) (802) showing the transferring of the reservation of the owned asset of the first user for the reservation of the second user from the second user to the third user within the messaging system for the reservation of the owned asset in accordance with one embodiment. For example, Anna may have booked Henry's vacation rental. Upon the reservation being confirmed, Henry may message the guest of the reservation, in this case, Anna (810). Anna may respond back to Henry (820). In the example, Anna may list her reservation and Bob may book the listed reservation. Upon transfer of the reservation of Henry's vacation rental from Anna to Bob, the messaging system may alert Henry (830) within the messaging system. Any new conversations that Henry may send (840) (860) to the guest of the reservation would therefore be received by Bob (850), not Anna. Furthermore, the messaging system may transfer the messaging from Henry and Anna to Henry and Bob within the same messaging interface (800) or individual messaging interfaces (801) (802) along with a message for why the reservation details have been transferred (830) (831) (832). In the example, if the messaging system is an individual messaging interface, then Henry may continue any correspondence with Anna in that interface (861) separate from Bob (801), and any new communication with Bob (862) in that interface (802).

The diagrams in FIGS. 1-8 illustrate the architecture, functionality, and operation of possible implementations of systems, methods, and computer program products according to various embodiments of the claimed subject matter. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description. but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for a resharing of an owned asset of a first user based on a reservation, comprising: reserving, by one or more processors of a computer, the owned asset of the first user by a second user;
listing, the owned asset of the first user for the reservation of the second user;
booking, by a third user, the owned asset of the first user for the reservation of the second user; and
transferring, by the one or more processors of a computer, the reservation of the owned asset of the first user for the reservation of the second user from the second user to the third user.

2. The computer implemented method of claim 1, wherein the reservation of the owned asset of the first user is associated with a authorization period for access to the owned asset of the first user by the second user for a reservation period includes one or more from a group of a start date, a end date, a start time, and a end time.

3. The computer implemented method of claim 2, wherein the booking, by the third user, the owned asset of the first user for the reservation of the second user comprises revoking the authorization period for access to the owned asset of the first user by the second user and granting the authorization period for access to the owned asset of the first user by the third user.

4. The computer implemented method of claim 2, wherein the reservation period ends and the third user reviews the owned asset of the first user and the first user reviews the third user.

5. The computer implemented method of claim 2, wherein the booking by a third user of the owned asset of the first user for the reservation of the second user is at least one of the following: the same reservation period, a shorter reservation period, and a longer reservation period.

6. The computer implemented method of claim 1, wherein a first price is associated with the owned asset of the first user for the reservation of the second user and a second price is associated with the owned asset of the first user for the reservation of the third user.

7. The computer implemented method of claim 6, wherein the second price includes one or more from a group of a price higher than the first price, a price lower than the first price, and a price equal to the first price.

8. The computer implemented method of claim 6, wherein the first user and the second user are compensated based on a difference in the first price associated with the owned asset of the first user for the reservation of the second user and the second price associated with the owned asset of the first user for the reservation of the third user.

9. The computer implemented method of claim 8, wherein the compensation includes one or more from a group of a monetary compensation and a reward compensation.

10. The computer implemented method of claim 1, wherein the transferring the reservation of the owned asset of the first user for the reservation of the second user from the second user to the third user comprising the modification of at least one of the following: a owned asset information, a identifying information, a contact information, a user verification, a payout information, a access information, a messaging information, and a review information.

11. A computer program product comprising: A computer readable storage medium readable by one or more processor and storing instructions for execution by the one or more processor for performing a method for a resharing of an owned asset of a first user based on a reservation, comprising: reserving, by one or more processors of a computer, the owned asset of the first user by a second user;
listing, the owned asset of the first user for the reservation of the second user;
booking, by a third user, the owned asset of the first user for the reservation of the second user; and
transferring, by the one or more processors of a computer, the reservation of the owned asset of the first user for the reservation of the second user from the second user to the third user.

12. The computer program product of claim 11, wherein the reservation of the owned asset of the first user is associated with a authorization period for access to the owned asset of the first user by the second user for a reservation period includes one or more from a group of a start date, a end date, a start time, and a end time.

13. The computer program product of claim 12, wherein the booking, by the third user, the owned asset of the first user for the reservation of the second user comprises revoking the authorization period for access to the owned asset of the first user by the second user and granting the authorization period for access to the owned asset of the first user by the third user.

14. The computer program product of claim 12, wherein the reservation period ends and the third user reviews the owned asset of the first user and the first user reviews the third user.

15. The computer program product of claim 12, wherein the booking by a third user of the owned asset of the first user for the reservation of the second user is at least one of the following: the same reservation period, a shorter reservation period, and a longer reservation period.

16. The computer program product of claim 11, wherein a first price is associated with the owned asset of the first user for the reservation of the second user and a second price is associated with the owned asset of the first user for the reservation of the third user.

17. The computer program product of claim 16, wherein the second price includes one or more from a group of a price higher than the first price, a price lower than the first price, and a price equal to the first price.

18. The computer program product of claim 16, wherein the first user and the second user are compensated based on a difference in the first price associated with the owned asset of the first user for the reservation of the second user and the second price associated with the owned asset of the first user for the reservation of the third user.

19. A system comprising:
a memory; one or more processors in communication with memory; and program instructions executable by the one or more processors via the memory to perform a method for a resharing of an owned asset of a first user based on a reservation, comprising: reserving, by one or more processors of a computer, the owned asset of the first user by a second user;
listing, the owned asset of the first user for the reservation of the second user;
booking, by a third user, the owned asset of the first user for the reservation of the second user; and
transferring, by the one or more processors of a computer, the reservation of the owned asset of the first user for the reservation of the second user from the second user to the third user.

20. The system of claim 19, wherein the reservation of the owned asset of the first user is associated with a authorization period for access to the owned asset of the first user by the second user for a reservation period includes one or more from a group of a start date, a end date, a start time, and a end time.
